(19) United States
(12) Patent Application Publication
(10) Pub. No.: US 2013/0156221 A1
(43) Pub. Date: Jun. 20, 2013

(54) SIGNAL PROCESSING APPARATUS AND SIGNAL PROCESSING METHOD

(71) Applicant: FUJITSU LIMITED, Kawasaki-shi (JP)

(72) Inventor: Naoshi MATSUO, Yokohama (JP)

(21) Appl. No.: 13/685,079

(22) Filed: Nov. 26, 2012

(30) Foreign Application Priority Data
Dec. 15, 2011 (JP) 2011-274742

(51) Int. Cl. H04B 15/00; H04R 3/00

(52) U.S. Cl. CPC H04B 15/00; H04R 3/005
USPC 381/92

(57) ABSTRACT

A signal processing apparatus includes an adder that acquires a plurality of input signals from a plurality of microphones and calculates an added value obtained by adding the input signals together, a subtracter that acquires a plurality of input signals from the plurality of microphones and calculates a subtracted value obtained by subtracting one input signal from the other input signal, and a determination unit that determines whether noise is included in the input signals based on the added value and the subtracted value.

### CROSS-REFERENCE TO RELATED APPLICATION

This application is based upon and claims the benefit of priority of the prior Japanese Patent Application No. 2011-274742, filed on Dec. 15, 2011, the entire contents of which are incorporated herein by reference.

### FIELD

The embodiments discussed herein are directed to a signal processing apparatus and the like.

### BACKGROUND

When wind hits a microphone, a diaphragm included in the microphone vibrates largely, so that noise is included in an input signal. Here, if noise is included in the input signal, when speech recognition is performed or a hands-free phone call is made, the accuracy of the speech recognition and the quality of the phone call degrade. Therefore, in conventional speech recognition and a hands-free phone call, a conventional apparatus which suppresses irregular noise generated when wind hits the microphone is used.

FIG. 10 is a diagram illustrating an example of the conventional apparatus. As illustrated in FIG. 10, a conventional apparatus 10 is connected to microphones 10a and 10b. The microphones 10a and 10b are spaced apart from each other by a predetermined distance. The conventional apparatus 10 includes a correlation analyzer 11, a noise analyzer 12, and a noise reduction unit 13.

The microphone 10a is a microphone which converts collected sound into an input signal Lin(t) and outputs the input signal Lin(t) to the conventional apparatus 10. The microphone 10b is a microphone which converts collected sound into an input signal Rin(t) and outputs the input signal Rin(t) to the conventional apparatus 10. Here, t corresponds to a sampling number of the input signal.

The correlation analyzer 11 calculates a correlation value r(t) between the input signal Lin(t) and the input signal Rin(t) by using the formula (1). In the formula (1), the correlation analyzer 11 sequentially changes the value of i from 1 to n and calculates a correlation value r(t). For example, the value of n is 128. The correlation analyzer 11 outputs the correlation value r(t) to the noise analyzer 12.

r(t)=ΣLin(t−i)Rin(t−i)/((ΣLin(t−i)²)^{1/2}(ΣRin(t−i)²)^{1/2}) (1)

When the value of the correlation value r(t) is small, the noise analyzer 12 determines that there is noise of wind and outputs control information to turn down volume to the noise reduction unit 13.

The noise reduction unit 13 adjusts the volumes of the input signals Lin(t) and Rin(t) and outputs the input signals Lin(t) and Rin(t) to an external apparatus. For example, when the noise reduction unit 13 receives the control information to turn down volume, the noise reduction unit 13 turns down the volumes of the input signals Lin(t) and Rin(t) and outputs the input signals Lin(t) and Rin(t) to the external apparatus.
Patent Document 1: Japanese Laid-open Patent Publication No. 2004-289762
Patent Document 2: Japanese Laid-open Patent Publication No. 2009-005133

However, in the conventional technique described above, there is a problem that noise included in a target input signal such as voice is not sufficiently suppressed.

For example, in the conventional technique, when wind blowing against the microphone is strong, the noise of the input signal can be suppressed. However, when wind blowing against the microphone is weak, the difference of correlation coefficient between a section including voice and a section including wind hitting noise is small, so that the noise is not accurately suppressed.

### SUMMARY

According to an aspect of an embodiment, a signal processing apparatus includes: an adder that acquires a plurality of input signals from a plurality of microphones and calculates an added value obtained by adding the input signals together; a subtracter that acquires a plurality of input signals from the plurality of microphones and calculates a subtracted value obtained by subtracting one input signal from the other input signal; and a determination unit that determines whether noise is included in the input signals based on the added value and the subtracted value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a signal processing apparatus according to a first embodiment;

FIG. 2 is a flowchart illustrating a processing procedure of the signal processing apparatus according to the first embodiment;

FIG. 3 is a diagram for explaining an effect of the present invention compared with a conventional apparatus;

FIG. 4 is a diagram illustrating a configuration of a signal processing apparatus according to a second embodiment;

FIG. 5 is a flowchart illustrating a processing procedure of the signal processing apparatus according to the second embodiment;

FIG. 6 is a diagram illustrating a configuration of a signal processing apparatus according to a third embodiment;

FIG. 7 is a flowchart illustrating a processing procedure of the signal processing apparatus according to the third embodiment;

FIG. 8 is a diagram for explaining another process of a gain calculator;

FIG. 9 is a diagram illustrating an example of a computer that executes a signal processing program; and

FIG. 10 is a diagram illustrating an example of a conventional apparatus.

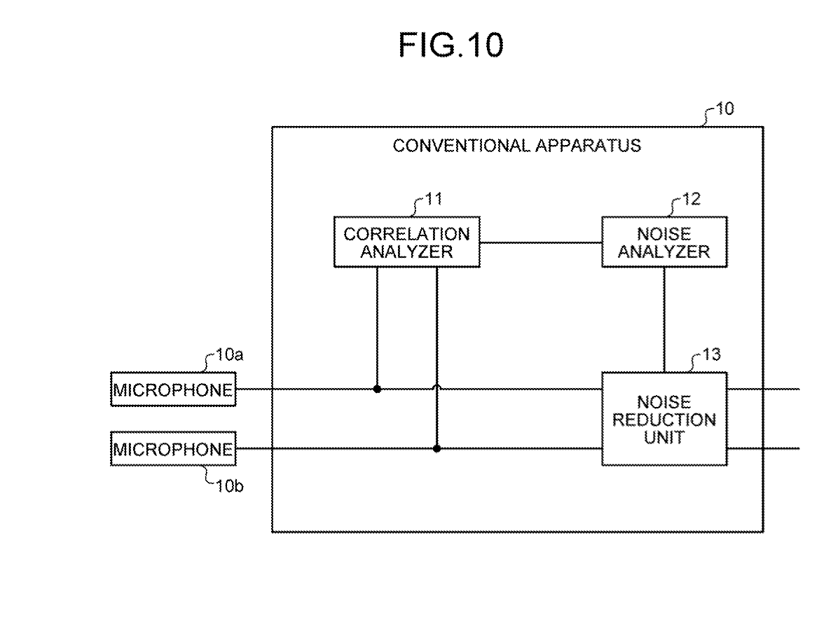

### DESCRIPTION OF EMBODIMENTS

Preferred embodiments of the present invention will be explained with reference to accompanying drawings. The present invention is not limited by the embodiments.

### [a] First Embodiment

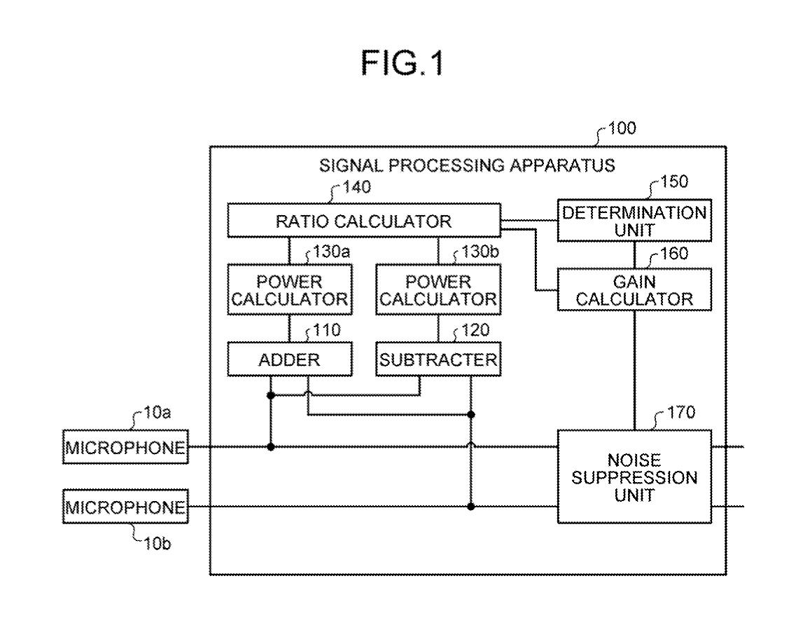

FIG. 1 is a diagram illustrating a configuration of a signal processing apparatus according to a first embodiment. As illustrated in FIG. 1, a signal processing apparatus 100 is connected to microphones 10a and 10b. The microphones 10a and 10b are spaced apart from each other by a predetermined distance.

The signal processing apparatus 100 includes an adder 110, a subtracter 120, and power calculators 130a and 130b. The signal processing apparatus 100 also includes a ratio calculator 140, a determination unit 150, a gain calculator 160, and a noise suppression unit 170.

The microphone 10a is a microphone which converts collected sound into an input signal Lin(t) and outputs the input signal Lin(t) to the signal processing apparatus 100. The microphone 10b is a microphone which converts collected sound into an input signal Rin(t) and outputs the input signal Rin(t) to the signal processing apparatus 100. Here, t corresponds to a sampling number of the input signal.

The adder 110 calculates an added value p(t) by adding the input signal Lin(t) and the input signal Rin(t) together. The added value p(t) is represented by the formula (2). The adder 110 outputs the added value p(t) to the power calculator 130a.

p(t)=Lin(t)+Rin(t) (2)

The subtracter 120 calculates an subtracted value m(t) by subtracting the input signal Rin(t) from the input signal Lin(t). The subtracted value m(t) is represented by the formula (3). The subtracter 120 outputs the subtracted value m(t) to the power calculator 130b.

m(t)=Lin(t)−Rin(t) (3)

The power calculator 130a calculates a power Ppow(t) by summing up squared values of the added value p(t) of different sampling numbers. The power Ppow(t) is represented by the formula (4). The power calculator 130a sequentially changes the value of j from 1 to n and calculates the power Ppow(t). The value of n is a natural number. For example, the value of n is 128. The power calculator 130a outputs the power Ppow(t) to the ratio calculator 140.

Ppow(t)=Σp(t−j)² (4)

The power calculator 130b calculates a power Mpow(t) by summing up squared values of the subtracted value m(t) of different sampling numbers. The power Mpow(t) is represented by the formula (5). The power calculator 130b sequentially changes the value of j from 1 to n and calculates the power Mpow(t). The value of n is a natural number. For example, the value of n is 128. The power calculator 130b outputs the power Mpow(t) to the ratio calculator 140.

Mpow(t)=Σm(t−j)² (5)

The ratio calculator 140 calculates a ratio v(t) of the power Ppow(t) and the power Mpow(t). For example, the ratio calculator 140 calculates the ratio v(t) by the formula (6). The ratio calculator 140 outputs the ratio v(t) to the determination unit 150 and the gain calculator 160. Here, v(t) may be a square root of the ratio of the power Ppow(t) and the power Mpow(t).

v(t)=Mpow(t)/Ppow(t) (6)

The determination unit 150 determines whether noise is included in the input signals Lin(t) and Rin(t) based on the ratio v(t). When the value of the ratio v(t) is greater than or equal to a predetermined threshold value, the determination unit 150 determines that noise is included in the input signals Lin(t) and Rin(t). The determination unit 150 outputs a determination result to the gain calculator 160.

The gain calculator 160 calculates a gain based on the ratio v(t). The gain calculator 160 first calculates g′(t) by the formula (7) and thereafter calculates a gain g(t) by the formula (8).

g′(t)=1−v(t) (7)

g(t)=max(g′(t),α) (8)

In the formula (8), α is a lower limit value greater than or equal to 0 and smaller than or equal to 1. The gain calculator 160 calculates g′(t) and thereafter calculates the larger value of g′(t) and α as the gain g(t). The gain calculator 160 outputs the gain g(t) to the noise suppression unit 170.

The gain calculator 160 may calculate the gain g(t) when noise is included in the input signals Lin(t) and Rin(t) based on the determination result of the determination unit 150. On the other hand, when noise is not included in the input signals Lin(t) and Rin(t), the gain calculator 160 may set 1 to the gain g(t) and output the gain g(t) to the noise suppression unit 170.

The noise suppression unit 170 suppresses noise by multiplying the input signals Lin(t) and Rin(t) by the gain g(t). For example, the noise suppression unit 170 generates output signals Lout(t) and Rout(t) from the input signals Lin(t) and Rin(t) and outputs the generated signals to an external apparatus. For example, the output signals Lout(t) and Rout(t) are represented by the formula (9) and the formula (10).

Lout(t)=g(t)Lin(t) (9)

Rout(t)=g(t)Rin(t) (10)

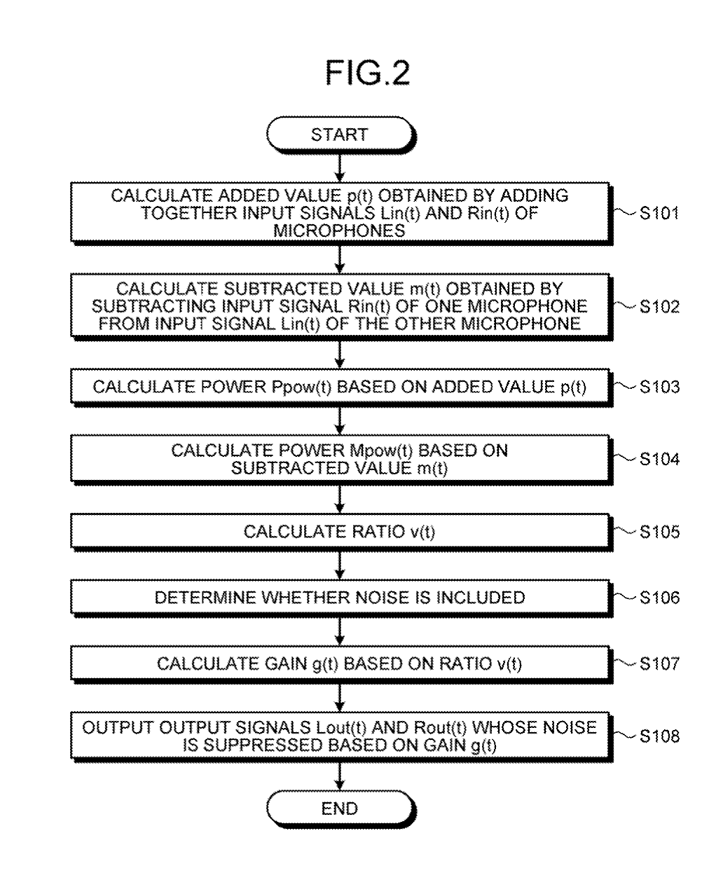

Next, a processing procedure of the signal processing apparatus 100 according to the first embodiment will be described. FIG. 2 is a flowchart illustrating a processing procedure of the signal processing apparatus according to the first embodiment. For example, the process illustrated in FIG. 2 is performed when input signals are received from the microphones 10a and 10b.

As illustrated in FIG. 2, the signal processing apparatus 100 calculates the added value p(t) obtained by adding together the input signals Lin(t) and Rin(t) of the microphones 10a and 10b (step S101). The signal processing apparatus 100 calculates the subtracted value m(t) obtained by subtracting the input signal Rin(t) of one microphone 10b from the input signal Lin(t) of the other microphone 10a (step S102).

The signal processing apparatus 100 calculates the power Ppow(t) based on the added value p(t) (step S103). The signal processing apparatus 100 calculates the power Mpow(t) based on the subtracted value m(t) (step S104).

The signal processing apparatus 100 calculates the ratio v(t) (step S105) and determines whether noise is included (step S106). The signal processing apparatus 100 calculates the gain g(t) based on the ratio v(t) (step S107). The signal processing apparatus 100 outputs the output signals Lout(t) and Rout(t) whose noise is suppressed based on the gain g(t) (step S108).

Next, effects of the signal processing apparatus 100 according to the first embodiment will be described. In the signal processing apparatus 100, the determination unit 150 determines whether noise is included in the input signals Lin(t) and Rin(t) based on the added value p(t) calculated by the adder 110 and the subtracted value m(t) calculated by the subtracter 120. Therefore, it is possible to accurately determine whether noise is included, so that noise included in the input signals can be sufficiently suppressed by using the determination result.

Generally, the lower the frequency, the stronger the correlation between the input signals. This is because the lower the frequency, the smaller the variation of waveforms in the time axis direction, so that the waveforms have similar shapes. An extreme example is a direct current. Therefore, in order to strengthen the correlation, the adder 110 sums up the input signals. On the other hand, in order to suppress the correlation, the subtracter 120 subtracts one input signal from the other input signal.

Therefore, for example, in a case where the input signals of the microphone have a correlation, such as cases of voice and noise in a driving car, a relationship of the formula (11) is established.

“power of(Lin(t)+Rin(t))”>>“power of(Lin(t)−Rin(t))” (11)

On the other hand, in a case where the correlation between the input signals of the microphone is weak, such as case of wind hitting noise, a relationship of the formula (12) is established.

“power of(Lin(t)+Rin(t))”≈“power of(Lin(t)−Rin(t))” (12)

Therefore, in the signal processing apparatus 100 according to the first embodiment, noise can be accurately detected by using the ratio of the “power of (Lin(t)−Rin(t))” based on the “power of (Lin(t)+Rin(t))”. Also, an appropriate gain can be calculated by using the ratio of the “power of (Lin(t)-Rin(t))” based on the “power of (Lin(t)+Rin(t))”, and a noise component included in the input signals can be suppressed by using the gain.

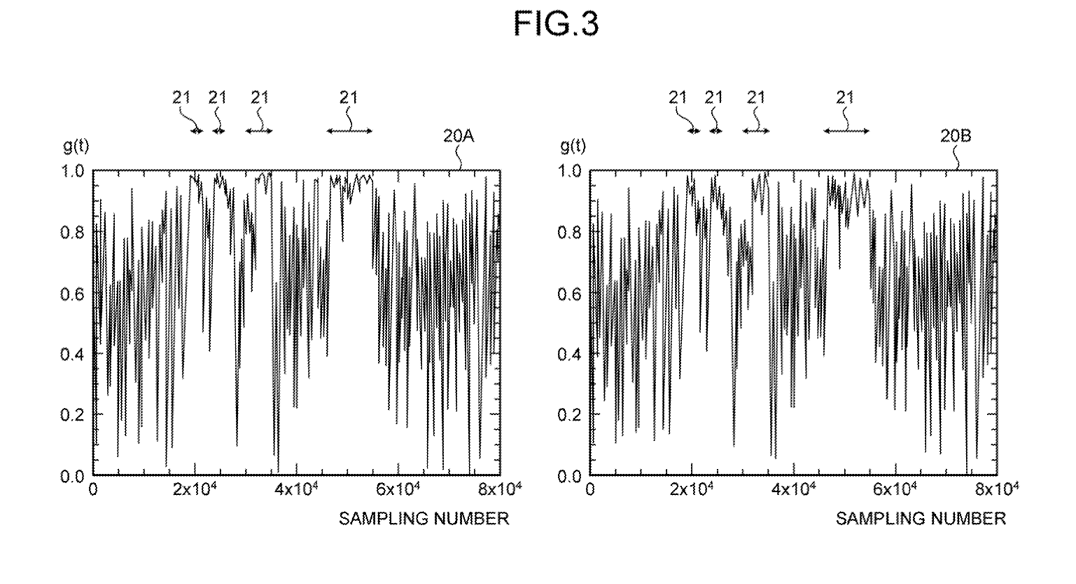

FIG. 3 is a diagram for explaining an effect of the present invention compared with a conventional apparatus. Signals 20A in FIG. 3 indicates a relationship between the sampling number and the gain g(t) of the conventional apparatus. Signals 20B in FIG. 3 indicates a relationship between the sampling number and the gain g(t) of the signal processing apparatus 100. Sections 21 in the signals 20A and 20B are sections including voice. When comparing the signals 20A and 20B, in the signals 20B, the gain g(t) in sections including only wind hitting noise is reduced while the gain g(t) in the sections 21 is substantially maintained at 1. Therefore, in the present invention, it is possible to turn down volume of a part of input signals including noise without turning down volume of whole input signals in voice sections.

By the way, in the signal processing apparatus 100 according to the first embodiment, the determination unit 150 determines whether noise is included based on the value of the ratio v(t). However, it is not limited to this. The determination unit 150 may obtain a difference between the Ppow(t) and the Mpow(t), and when the difference value is smaller than a predetermined threshold value, the determination unit 150 may determine that noise is included in the input signals.

The signal processing apparatus 100 may be configured by integrating the determination unit 150 and the gain calculator 160 together.

### [b] Second Embodiment

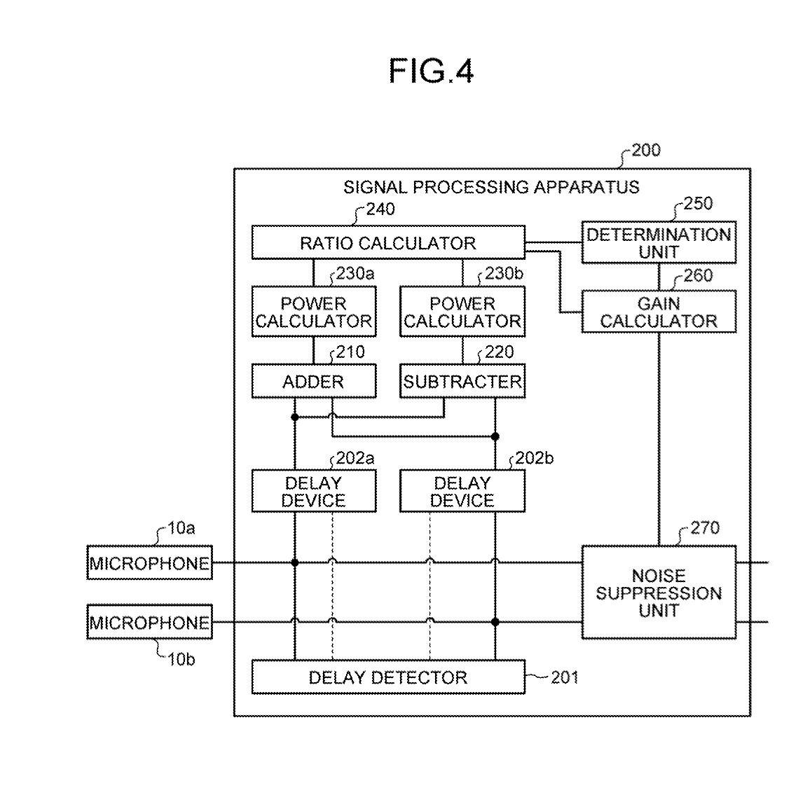

Next, a signal processing apparatus according to a second embodiment will be described. FIG. 4 is a diagram illustrating a configuration of the signal processing apparatus according to the second embodiment. As illustrated in FIG. 4, a signal processing apparatus 200 is connected to the microphones 10a and 10b. The microphones 10a and 10b are spaced apart from each other by a predetermined distance. The description about the microphones 10a and 10b is the same as that in the first embodiment.

The signal processing apparatus 200 includes a delay detector 201 and delay devices 202a and 202b. The signal processing apparatus 200 also includes an adder 210, a subtracter 220, and power calculators 230a and 230b. The signal processing apparatus 200 also includes a ratio calculator 240, a determination unit 250, a gain calculator 260, and a noise suppression unit 270.

The delay detector 201 calculates a correlation coefficient c(d) between the input signal Lin(t) and the input signal Rin(t) by the formula (13). The delay detector 201 changes a delay amount d and detects a delay amount dmax by which the value of correlation coefficient c(d) is the maximum.

c(d)=ΣLin(t)Rin(t−d)/((ΣLin(t)²)^{1/2}(ΣRin(t−d)²)^{1/2}) (13)

After detecting the dmax, the delay detector 201 calculates a delay amount dL applied to the input signal from the microphone 10a and a delay amount dR applied to the input signal from the microphone 10b in order to synchronize the input signals inputted from the microphones 10a and 10b. A calculation example of the delay amounts dL and dR will be described below.

When the value of the dmax is greater than or equal to 0, the delay detector 201 sets the value of dL to 0 and sets the value of dR to the value of the dmax. Then, the delay detector 201 outputs the dL to the delay device 202a and outputs the dR to the delay device 202b.

On the other hand, when the value of the dmax is smaller than 0, the delay detector 201 sets the value of dL to the absolute value of the dmax and sets the value of dR to 0. Then, the delay detector 201 outputs the dL to the delay device 202a and outputs the dR to the delay device 202b.

The delay device 202a performs a delay process of the input signal Lin(t) from the microphone 10a. The delay device 202a outputs an input signal Lin(t−dL) obtained by performing a delay process on the input signal Lin(t) to the adder 210 and the subtracter 220.

The delay device 202b performs a delay process of the input signal Rin(t) from the microphone 10b. The delay device 202b outputs an input signal Rin(t−dR) obtained by performing a delay process on the input signal Rin(t) to the adder 210 and the subtracter 220.

The adder 210 calculates an added value p(t) by adding together the input signals Lin(t−dL) and Rin(t−dR) whose delay amounts are adjusted. The adder 210 outputs the added value p(t) to the power calculator 230a.

The subtracter 220 calculates an subtracted value m(t) by subtracting the input signal Rin(t−dR) from the input signal Lin(t−dL). The subtracter 220 outputs the subtracted value m(t) to the power calculator 230b.

The descriptions about the power calculators 230a and 230b, the ratio calculator 240, the determination unit 250, the gain calculator 260, and the noise suppression unit 270 are the same as those of the power calculators 130a and 130b, the ratio calculator 140, the determination unit 150, the gain calculator 160, and the noise suppression unit 170 illustrated in FIG. 1.

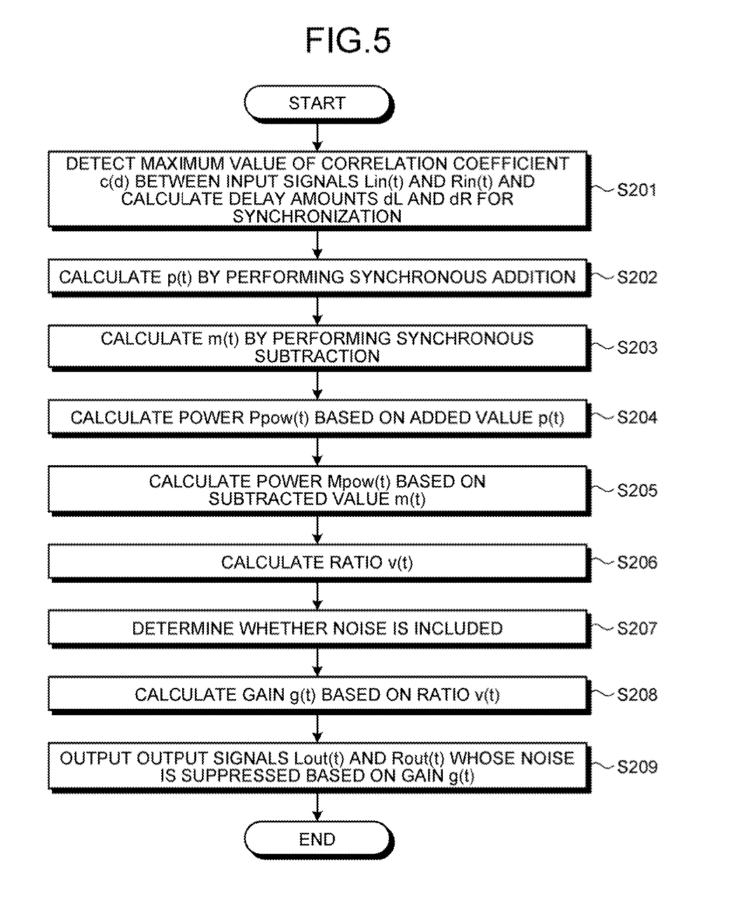

Next, a processing procedure of the signal processing apparatus 200 according to the second embodiment will be described. FIG. 5 is a flowchart illustrating the processing procedure of the signal processing apparatus according to the second embodiment. For example, the process illustrated in FIG. 5 is performed when input signals are received from the microphones 10a and 10b.

The signal processing apparatus 200 detects the maximum value of the correlation coefficient c(d) between the input signal Lin(t) and the input signal Rin(t) and calculates the delay amounts dL and dR for synchronization (step S201). The signal processing apparatus 200 calculates the p(t) by performing synchronous addition (step S202) and calculates the m(t) by performing synchronous subtraction (step S203).

The signal processing apparatus 200 calculates the power Ppow(t) based on the added value p(t) (step S204). The signal processing apparatus 200 calculates the power Mpow(t) based on the subtracted value m(t) (step S205).

The signal processing apparatus 200 calculates the ratio v(t) (step S206) and determines whether noise is included (step S207). The signal processing apparatus 200 calculates the gain g(t) based on the ratio v(t) (step S208). The signal processing apparatus 200 outputs the output signals Lout(t) and Rout(t) whose noise is suppressed based on the gain g(t) (step S209).

Next, effects of the signal processing apparatus 200 according to the second embodiment will be described. In the signal processing apparatus 200, the delay detector 201 calculates the delay amounts dL and dR and the delay devices 202a and 202b synchronize the input signals. In the signal processing apparatus 200, the determination unit 250 determines whether noise is included in the input signals Lin(t) and Rin(t) based on the added value p(t) calculated by the adder 210 and the subtracted value m(t) calculated by the subtracter 220. Therefore, even if the timings when voice of a user is collected by the microphones 10a and 10b are different from each other, the input signals can be synchronized by adjusting the delay amounts. Thus, it is possible to accurately determine whether noise is included in a direction of a user whose voice is desired to be recorded, so that noise included in the input signals can be suppressed by using the determination result.

### [c] Third Embodiment

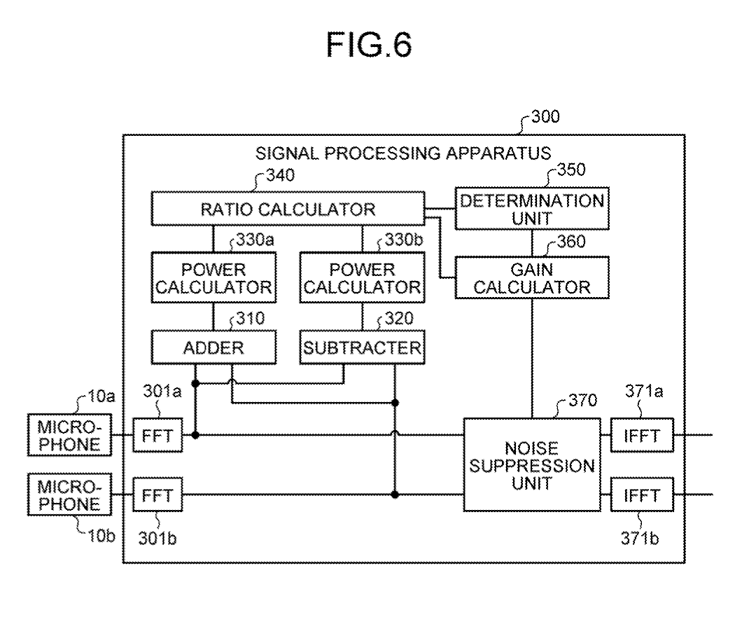

Next, a signal processing apparatus according to the third embodiment will be described. FIG. 6 is a diagram illustrating a configuration of the signal processing apparatus according to the third embodiment. As illustrated in FIG. 6, a signal processing apparatus 300 is connected to the microphones 10a and 10b. The microphones 10a and 10b are spaced apart from each other by a predetermined distance. The description about the microphones 10a and 10b is the same as that in the first embodiment.

The signal processing apparatus 300 includes FFTs (Fast Fourier Transforms) 301a and 301b, an adder 310, a subtracter 320, and power calculators 330a and 330b. The signal processing apparatus 300 also includes a ratio calculator 340, a determination unit 350, a gain calculator 360, a noise suppression unit 370, and IFFTs (Inverse FFTs) 371a and 371b.

The FFT 301a positions a Hanning window with 50% overlap on the input signal Lin(t) acquired from the microphone 10a and converts the input signal Lin(t) into a signal on the frequency axis by fast Fourier transform. The input signal Lin(t) converted into a signal on the frequency axis is represented as LIN(i, f). Here, i is a number of an analysis frame on which FFT is performed and f indicates the frequency. The FFT 301a outputs the LIN(i, f) to the adder 310, the subtracter 320, and the noise suppression unit 370.

The FFT 301b positions a Hanning window with 50% overlap on the input signal Rin(t) acquired from the microphone 10b and converts the input signal Rin(t) into a signal on the frequency axis by fast Fourier transform. The input signal Rin(t) converted into a signal on the frequency axis is represented as RIN(i, f). The FFT 301b outputs the RIN(i, f) to the adder 310, the subtracter 320, and the noise suppression unit 370. The FFTs 301a and 301b are an example of a frequency converter.

The adder 310 is a processing unit which calculates an added value p(i, f) by adding the input signal LIN(i, f) and the input signal RIN(i, f) together. The added value p(i, f) is represented by the formula (14). The adder 310 outputs the added value p(i, f) to the power calculator 330a.

p(i,f)=LIN(i,f)+RIN(i,f) (14)

The subtracter 320 calculates a subtracted value m(i, f) by subtracting the input signal RIN(i, f) from the input signal LIN(i, f). The subtracted value m(i, f) is represented by the formula (15). The subtracter 320 outputs the subtracted value m(i, f) to the power calculator 330b.

m(i,f)=LIN(i,f)−RIN(i,f) (15)

The power calculator 330a calculates a power Ppow(i, f) by summing up squared values of the added value p(i, f) of different frame numbers. The power Ppow(i, f) is represented by the formula (16). The power calculator 330a sequentially changes the value of j from 1 to n and calculates the power Ppow(i, f). The value of n is a natural number. For example, the value of n is 128. The power calculator 330a outputs the power Ppow(i, f) to the ratio calculator 340.

Ppow(i,f)=Σp(i−j,f) (16)

The power calculator 330b calculates a power Mpow(i, f) by summing up squared values of the subtracted value m(i, f) of different frame numbers. The power Mpow(i, f) is represented by the formula (17). The power calculator 330b sequentially changes the value of j from 1 to n and calculates the power Mpow(i, f). The value of n is a natural number. For example, the value of n is 128. The power calculator 330b outputs the power Mpow(i, f) to the ratio calculator 340.

Mpow(i,f)=Σm(i−j,f) (17)

The ratio calculator 340 calculates a ratio v(i, f) of the power Ppow(i, f) and the power Mpow(i, f). For example, the ratio calculator 340 calculates the ratio v(i, f) by the formula (18). The ratio calculator 340 outputs the ratio v(i, f) to the determination unit 350 and the gain calculator 360.

v(i,f)=Mpow(i,f)/Ppow(i,f) (18)

The determination unit 350 determines whether noise is included in the input signals LIN(i, f) and RIN(i, f) based on the ratio v(i, f). When the value of the ratio v(i, f) is greater than or equal to a predetermined threshold value, the determination unit 350 determines that noise is included in the input signals LIN(i, f) and RIN(i, f). The determination unit 350 outputs a determination result to the gain calculator 360.

The gain calculator 360 calculates a gain based on the ratio v(i, f). The gain calculator 360 first calculates g′(i, f) by the formula (19) and thereafter calculates a gain g(i, f) by the formula (20).

g′(i,f)=1−v(i,f) (19)

g(i,f)=max(g′(i,f),α) (20)

In the formula (20), α is a lower limit value greater than or equal to 0 and smaller than or equal to 1. The gain calculator 360 calculates g′(i, f) and thereafter calculates the larger value of g′(i, f) and α as the gain g(i, f). The gain calculator 360 outputs the gain g(i, f) to the noise suppression unit 370.

The gain calculator 360 may calculate the gain g(i, f) when noise is included in the input signals LIN(i, f) and RIN(i, f) based on the determination result of the determination unit 350. On the other hand, when noise is not included in the input signals LIN(i, f) and RIN(i, f), the gain calculator 360 may set 1 to the gain g(i, f) and output the gain g(i, f) to the noise suppression unit 370.

The noise suppression unit 370 suppresses noise by multiplying the input signals LIN(i, f) and RIN(i, f) by the gain g(i, f). For example, the noise suppression unit 370 generates output signals LOUT(i, f) and ROUT (i, f) from the input signals LIN(i, f) and RIN(i, f) and outputs the generated signals to the IFFTs 371a and 371b. For example, the output signals LOUT(i, f) and ROUT (i, f) are represented by the formulas (21) and (22).

LOUT(i,f)=g(i,f)LIN(i,f) (21)

ROUT(i,f)=g(i,f)RIN(i,f) (22)

The IFFT 371a is a processing unit which generates a signal Lin(t) on the time axis by performing an inverse Fourier transform and 50% overlap addition on the LOUT(i, f). The IFFT 371a outputs the output signal Lin(t) to an external apparatus.

The IFFT 371b is a processing unit which generates a signal Rin(t) on the time axis by performing an inverse Fourier transform and 50% overlap addition on the ROUT(i, f). The IFFT 371b outputs the output signal Rin(t) to an external apparatus.

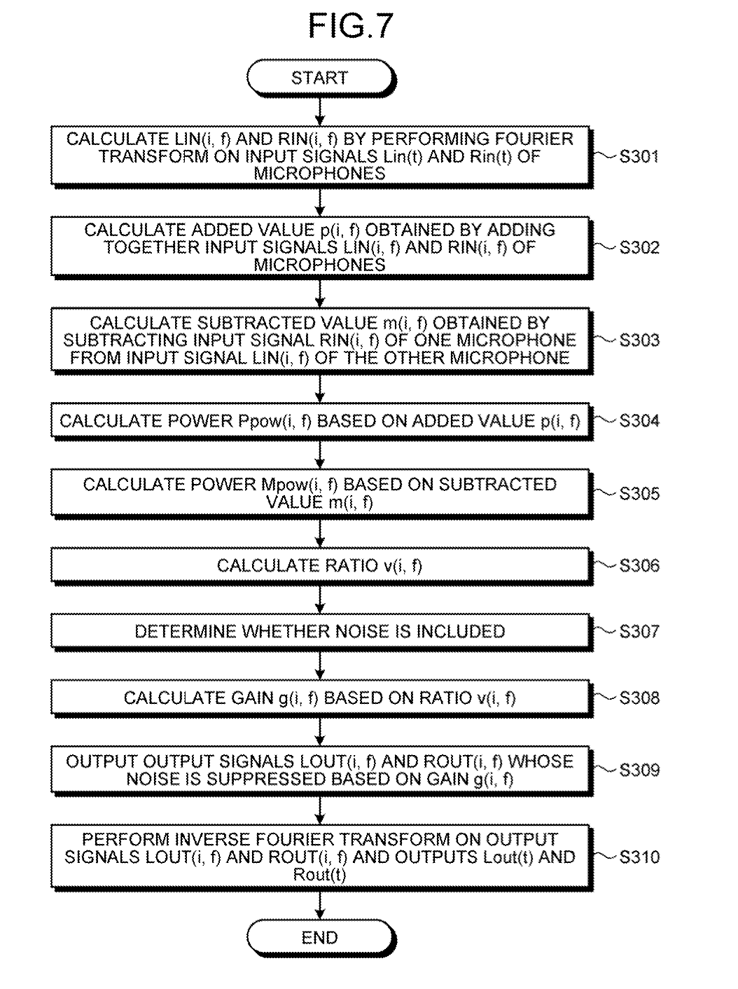

Next, a processing procedure of the signal processing apparatus 300 according to the third embodiment will be described. FIG. 7 is a flowchart illustrating the processing procedure of the signal processing apparatus according to the third embodiment. For example, the process illustrated in FIG. 7 is performed when input signals are received from the microphones 10a and 10b.

As illustrated in FIG. 7, the signal processing apparatus 300 calculates the LIN(i, f) and the RIN(i, f) by performing a Fourier transform on the input signals Lin(t) and Rin(t) of the microphones (step S301). The signal processing apparatus 300 calculates the added value p(i, f) obtained by adding together the input signals LIN(i, f) and RIN(i, f) of the microphones (step S302).

The signal processing apparatus 300 calculates the subtracted value m(i, f) obtained by subtracting the input signal RIN(i, f) of one microphone from the input signal LIN(i, f) of the other microphone (step S303). The signal processing apparatus 300 calculates the power Ppow(i, f) based on the added value p(i, f) (step S304).

The signal processing apparatus 300 calculates the power Mpow(i, f) based on the subtracted value m(i, f) (step S305). The signal processing apparatus 300 calculates the ratio v(i, f) (step S306) and determines whether noise is included (step S307).

The signal processing apparatus 300 calculates the gain g(i, f) based on the ratio v(i, f) (step S308). The signal processing apparatus 300 outputs the output signals LOUT(i, f) and ROUT(i, f) whose noise is suppressed based on the gain g(i, f) (step S309). The signal processing apparatus 300 performs an inverse Fourier transform on the output signals LOUT(i, f) and ROUT(i, f) and outputs Lout(t) and Rout(t) (step S310).

Next, effects of the signal processing apparatus 300 according to the third embodiment will be described. The signal processing apparatus 300 performs a Fourier transform on the input signals Lin(t) and Rin(t) and determines whether there is noise at each frequency. Then, the signal processing apparatus 300 calculates the gain g(i, f) at each frequency and multiplies the input signals LIN(i, f) and RIN(i, f) at each frequency by the gain g(i, f). Therefore, noise at each frequency can be suppressed.

### [d] Fourth Embodiment

The processes of the aforementioned signal processing apparatuses 100 to 300 are an example. Hereinafter, another process of the signal processing apparatuses of the present invention will be described as a fourth embodiment. The process according to the fourth embodiment will be described with reference to the configuration diagram in FIG. 1.

Another process of the gain calculator 160 will be described. Although the gain calculator 160 calculates the gain g(t) by using the formula (7) and the formula (8), it is not limited to this. The gain calculator 160 may calculate the gain g(t) by using a decision table indicating a relationship between the gain g(t) and the ratio v(t) for each distance between the microphones 10a and 10b.

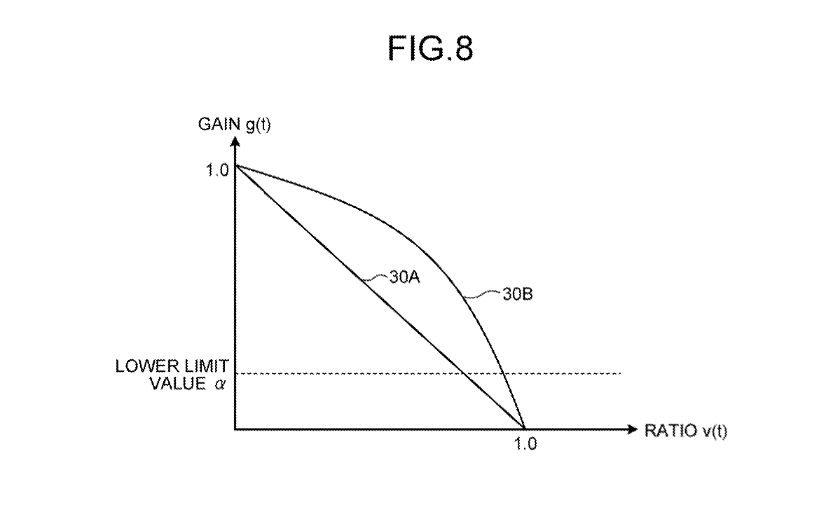

FIG. 8 is a diagram for explaining the other process of the gain calculator. For example, the gain calculator 160 defines that when the distance between the microphones 10a and 10b is 4.2 cm, the relationship between the gain g(t) and the ratio v(t) is a relationship changing as illustrated by a straight line 30A in FIG. 8. The relationship illustrated by the straight line 30A corresponds to the relationship of the formula (7).

On the other hand, the gain calculator 160 defines that when the distance between the microphones 10a and 10b is smaller than 4.2 cm, the relationship changes as illustrated by a curved line 30B in FIG. 8. In other words, the gain calculator 160 sets the change rate of the gain g(t) larger than that indicated by the straight line 30A when the value of the ratio v(t) is about 1 to 0.8. The gain calculator 160 performs the process as described above, so that it is possible to accurately suppress noise corresponding to the change of characteristics of the input signals caused by the difference of the distance between the microphones.

The gain calculator 160 may acquire information of the distance between the microphones 10a and 10b in any manner. A user may input the distance into the signal processing apparatus 100 by using an input device.

Another process of the power calculator 130a will be described. The power calculator 130a obtains the power Ppow(t) based on the formula (4). However, instead of the power Ppow(t), an average Pamp(t) of the absolute values may be calculated. For example, the power calculator 130a obtains the average of the absolute values by the formula (23).

Pamp(t)=Σ|p(t−j)| (23)

Similarly, the power calculator 130b may calculate an average Mamp(t) of the absolute values instead of the power Mpow(t). For example, the power calculator 130b obtains the average of the absolute values by the formula (24).

Mamp(t)=Σ|m(t−j)| (24)

It is known that when the average of the absolute values is obtained, the processing load of the computer is smaller than when the power is obtained. Therefore, when it is configured so that the power calculators 130a and 130b calculate the average of the absolute values instead of the power, the cost of the signal processing apparatus 100 can be reduced.

By the way, the signal processing apparatus 100 may suppress noise by using microphones 10c and 10d not illustrated in the drawings in addition to the pair of microphones 10a and 10b. For example, the signal processing apparatus 100 calculates the ratio v(t) from the microphones 10a and 10b by the same process as that in the first embodiment. The v(t) calculated from the microphones 10a and 10b is defined as v1(t).

Also, the ratio v(t) is calculated from the microphones 10c and 10d by the same process as that in the first embodiment. The v(t) calculated from the microphones 10c and 10d is defined as v2(t). When both the v1(t) and v2(t) are greater than a predetermined threshold value, the signal processing apparatus 100 may adjust the input signals Lin(t) and Rin(t) by the gain g(t).

For example, the signal processing apparatus 100 may obtain g′(t) by the formula (25) or the formula (26). The processes after calculating the g′(t) is the same as that in the first embodiment. The g′(t) may be obtained by subtracting the average value of the v1(1) and v2(2) from 1.

g′(t)=1−v1(t) (25)

g′(t)=1−v2(t) (26)

In this way, the gain g(t) is calculated by using the microphones 10a to 10d, so that it is possible to accurately suppress noise of the input signals even when there are a plurality of users.

The processing units included in the signal processing apparatuses 100 to 300 described in the first to the fourth embodiments correspond to integrated devices such as, for example, ASIC (Application Specific Integrated Circuit) and FPGA (Field Programmable Gate Array). Also, the processing units correspond to electronic circuits such as CPU and MPU (Micro Processing Unit).

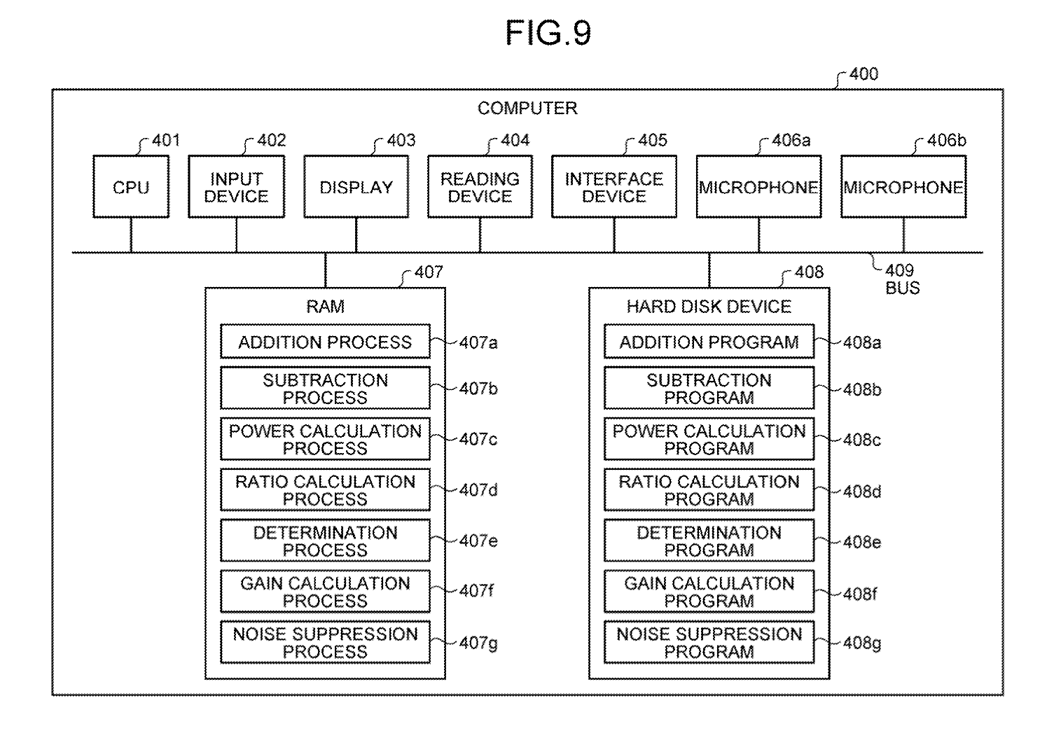

Next, an example of a computer that executes a signal processing program which realizes the same function as that of the signal processing apparatuses 100 to 300 described in the embodiments will be described. FIG. 9 is a diagram illustrating an example of the computer that executes the signal processing program.

As illustrated in FIG. 9, a computer 400 includes a CPU 401 that performs various calculation processes, an input device 402 that receives input of data from a user, and a display 403. The computer 400 also includes a reading device 404 that reads a program and the like from a storage medium and an interface device 405 that transmits and receives data to and from another computer through a network. The computer 400 also includes microphones 406a and 406b. The computer 400 also includes a RAM 407 that temporarily stores various information and a hard disk device 408. The devices 401 to 408 are connected to a bus 409.

The hard disk device 408 includes, for example, an addition program 408a, a subtraction program 408b, a power calculation program 408c, a ratio calculation program 408d, a determination program 408e, a gain calculation program 408f, and a noise suppression program 408g. The CPU 401 reads the programs 408a to 408g and develops the programs in the RAM 407.

The addition program 408a functions as an addition process 407a. The subtraction program 408b functions as a subtraction process 407b. The power calculation program 408c functions as a power calculation process 407c. The ratio calculation program 408d functions as a ratio calculation process 407d. The determination program 408e functions as a determination process 407e. The gain calculation program 408f functions as a gain calculation process 407f. The noise suppression program 408g functions as a noise suppression process 407g.

For example, the addition process 407a corresponds to the adder 110. The subtraction process 407b corresponds to the subtracter 120. The power calculation process 407c corresponds to the power calculators 130a and 130b. The ratio calculation process 407d corresponds to the ratio calculator 140. The determination process 407e corresponds to the determination unit 150. The gain calculation process 407f corresponds to the gain calculator 160. The noise suppression process 407g corresponds to the noise suppression unit 170.

The programs 408a to 408g need not necessarily be stored in the hard disk device 408 from the beginning. For example, the programs are stored in a “portable physical medium” such as a flexible disk (FD), a CD-ROM, a DVD disk, a magneto-optical disk, and an IC card which are inserted in the computer 400. The computer 400 may read the programs 408a to 408g from these media and execute the programs. The programs of the signal processing apparatuses 200 and 300 described in the second to the fourth embodiments are executed by the computer 400 in the same manner as the programs of the signal processing apparatus 100.

According to the disclosed signal processing apparatus, there is an effect that noise included in the input signal can be suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A signal processing apparatus comprising:
an adder that acquires a plurality of input signals from a plurality of microphones and calculates an added value obtained by adding the input signals together;
a subtracter that acquires a plurality of input signals from the plurality of microphones and calculates a subtracted value obtained by subtracting one input signal from the other input signal; and
a determination unit that determines whether noise is included in the input signals based on the added value and the subtracted value.

2. The signal processing apparatus according to claim 1, further comprising:
a gain calculator that calculates a gain based on the added value and the subtracted value; and
a noise suppression unit that suppresses noise of the input signals based on the gain calculated by the gain calculator.

3. The signal processing apparatus according to claim 1, wherein the determination unit determines that noise is included in the input signals when a difference between the added value and the subtracted value is smaller than a threshold value.

4. The signal processing apparatus according to claim 1, further comprising
a ratio calculator that calculates a ratio of the subtracted value to the added value,
wherein the determination unit determines that noise is included in the input signals when a value of the ratio calculated by the ratio calculator is greater than or equal to a threshold value.

5. The signal processing apparatus according to claim 1, further comprising:
a delay detector that acquires input signals from the plurality of microphones, changes a delay amount of each of the input signals, and detects delay amounts by which a correlation coefficient of the input signals is a maximum; and
a delay unit that delays each of the input signals based on the delay amounts detected by the delay detector,
wherein the adder calculates the added value based on the input signals delayed by the delay unit, and
the subtracter calculates the subtracted value based on the input signals delayed by the delay unit.

6. The signal processing apparatus according to claim 1, further comprising
a frequency converter that acquires input signals from the plurality of microphones and converts each of the input signals into a signal on a frequency axis,
wherein the adder calculates the added value based on each signal on the frequency axis, and
the subtracter calculates the subtracted value based on each signal on the frequency axis.

7. The signal processing apparatus according to claim 2, further comprising
a ratio calculator that calculates a ratio of the subtracted value to the added value,
wherein the gain calculator calculates the gain based on a value of the ratio and information indicating a relationship between the gain and the value of the ratio which varies according to a distance between the microphones.

8. The signal processing apparatus according to claim 4, wherein the ratio calculator calculates a ratio of a value obtained by squaring the subtracted value to a value obtained by squaring the added value.

9. The signal processing apparatus according to claim 4, wherein the ratio calculator calculates a ratio of an absolute value of the subtracted value to an absolute value of the added value.

10. The signal processing apparatus according to claim 2, wherein
the adder calculates a first added value obtained by adding together input signals acquired from a first microphone and a second microphone and a second added value obtained by adding together input signals acquired from a third microphone and a fourth microphone,
the subtracter calculates a first subtracted value obtained by subtracting an input signal acquired from the second microphone from an input signal acquired from the first microphone and a second subtracted value obtained by subtracting an input signal acquired from the fourth microphone from an input signal acquired from the third microphone, and
the gain calculator calculates a gain based on the first added value, the second added value, the first subtracted value, and the second subtracted value.

11. A signal processing method comprising:
acquiring a plurality of input signals from a plurality of microphones and calculating an added value obtained by adding the input signals together;
acquiring a plurality of input signals from the plurality of microphones and calculating a subtracted value obtained by subtracting one input signal from the other input signal; and
determining whether noise is included in the input signals based on the added value and the subtracted value.

12. A computer-readable recording medium having stored therein a program for causing a computer to execute a signal processing procedure comprising:
acquiring a plurality of input signals from a plurality of microphones and calculating an added value obtained by adding the input signals together;
acquiring a plurality of input signals from the plurality of microphones and calculating a subtracted value obtained by subtracting one input signal from the other input signal; and
determining whether noise is included in the input signals based on the added value and the subtracted value.
